(19) United States
(12) Patent Application Publication
(10) Pub. No.: US 2006/0072167 A1
(43) Pub. Date: Apr. 6, 2006

(54) Method of image signal modulation based on light source luminosity

(76) Inventors: Michael Yang, Taipei (TW); Ming-Hsun Shen, Taipei (TW); Ta-Yi Lee, Taipei (TW)

Correspondence Address: HARNESS, DICKEY & PIERCE, P.L.C., P.O. BOX 8910, RESTON, VA, 20195, US

(21) Appl. No.: 10/953,456

(22) Filed: Sep. 30, 2004

(51) Int. Cl. H04N 1/40

(52) U.S. Cl. 358/461

(57) ABSTRACT

An image signal modulation method is applicable to an optical scanner to obtain compensated image when the light source is not stable during starting. It first scans a document to get corresponding optoelectronic signals of pixels at different positions. Then, it transfers the optoelectronic signals to a memory unit for adjusting a shading table and parameters of an ASIC to compensate the brightness of each pixel, resemble a condition of stable luminosity, and generate an updated shading table. Finally, it compensates the optoelectronic signals of each corresponding pixel according to the updated shading table, and obtains the scanned image data. The compensation solves the problem of luminosity changing and variation during starting of scanning so that an instant use of scanner is available.

### BACKGROUND OF THE INVENTION

1. Field of the Invention

The invention generally relates to a method for modulating scanned image signal by compensation of the luminosity of light source, and in particular relates to an image signal modulation method applicable to optical scanner to obtain compensated image when the light source is not stable during starting.

2. Related Art

Scanner is a useful device to capture image. A flatbed scanner, for example, includes a composition of a flatbed window to carry an object (a document or a picture) to be scanned, and an optoelectronic module for transforming image into electrical signals. The optoelectronic module includes image sensor, and mirrors and lens to focus image to the sensor. The image sensor, such as charge-coupled device (CCD), includes a plurality of optical sensing elements (such as an array of light-sensitive diodes) sensible to the light intensity projected on the elements that cause each element accumulating an electric charge. The element dumps its charge into an amplifier that converts the charge into a voltage. By repeating this process, a control circuit converts the entire contents of the array to a varying voltage, which is digitized via an A/D converter into image data. Therefore, the user can process, edit, store and output the image by using computer software.

In a common scanner or multi-function printer, the optoelectronic module generally uses a cold cathode fluorescent lamp (CCFL) as the light source.

Though CCFL has the advantages of high luminosity, lower power consumption and long life, etc., it has a main disadvantage of needing a longer time period to warm up itself to a maximum luminosity. FIG. 1 illustrates a flatbed window 10 and its coordinates. A time period of warming up the CCFL is needed to increase the luminosity of the CCFL up to a steady state. As shown in FIG. 2, it illustrates an example of signals of pixels along X-axis on a Yn position. In other words, FIG. 2 is the diagram corresponding to the image sensor which is on a Yn position and which gets the signals. The signal deviation on different X positions is a certain characteristic of the CCFL. A shading table stored in the memory of the scanner or multi-function printer can compensate the deviation of every point and succeed the scanning of pictures.

Under ordinary temperature, the warm-up time is about 1 to 3 minutes, and is longer when working under a lower temperature at cold temperature area. As a result, users at cold temperature area require a longer time to start using the scanner. This is inconvenient and even confused to the user that he or she may think about failure and reject the scanner.

Therefore, it is desired to have a scanner or multi-function printer capable of instant use without a need of waiting the warm-up.

### SUMMARY OF THE INVENTION

The object of the invention is to provide an image signal modulation method applicable to an optical scanner to obtain compensated image when the light source is not stable during starting. The method helps user starting instant-scan or previous-print after turning on the scanner or the multi-function printer so as to get instant response and convenience of operation.

The method according to the invention includes the following steps. After turning on the machine while the light luminosity is still unstable, scanning a document gets corresponding optoelectronic signals of pixels at different positions.

Transferring the optoelectronic signals to a memory unit of the optoelectronic module for adjusting a shading table and parameters of an application specific integrated circuit (ASIC) to compensate the brightness of each pixel, resemble a condition of stable luminosity, and generate an updated shading table.

Finally, compensate the optoelectronic signals of each corresponding pixel according to the updated shading table, and obtain the scanned image data. The compensation solves the problem of luminosity changing and variation during starting of scanning so that an instant use of scanner is available.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is an illustration of coordinates of a flatbed window applied to a scanner;

FIG. 2 is a diagram of respectively corresponding optoelectronic signals and pixels on X-axis, and the signals and the pixels are obtained by image sensor of the optoelectronic module while the image sensor is on a position Yn;

FIG. 3 is a flowchart of image signal modulation method of the invention applying compensation of luminosity of light source;

FIG. 4 is a typical diagram of optoelectronic signals of pixels on a position of Y-axis; and

FIG. 5 is a diagram of respectively corresponding optoelectronic signals and pixels on different positions (Y1, Y2, . . . Yn) of Y-axis after compose the diagram of the pixels on every position of Y-axis and respective optoelectronic signals.

### DETAILED DESCRIPTION OF THE INVENTION

The invention provides an image signal modulation method applicable to optical scanner or multi-function printer to obtain compensated image when the light source is not stable during starting. An optoelectronic module in the optical scanner mainly includes a light source, an image sensor and a memory unit.

The memory unit is stored with a shading table for compensation of each pixel when the user wants to instantly scan or previously print a document. The compensation modifies the brightness of pixels to prevent them from being too dark or from being too bright caused by luminosity variations of the light source at different portions.

After turning on the scanner or the multi-function printer and the light luminosity still being unstable, the invention generates compensated image data and helps user starting instant-scan or previous-print. An instant-scan or previous-print can be obtained without the need of warming up the light source.

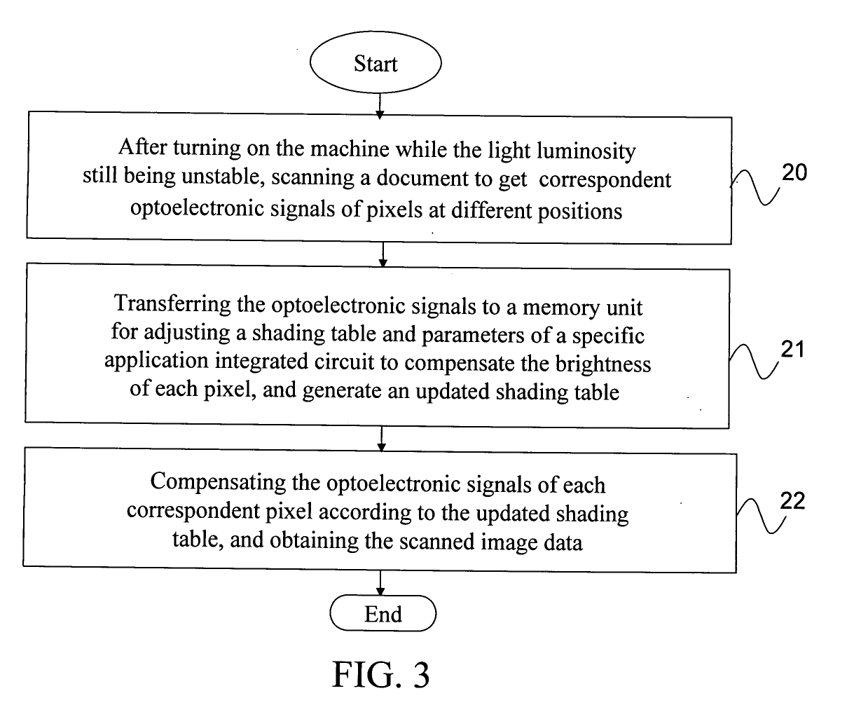

FIG. 3 is a flowchart of image signal modulation method of the invention applying compensation of luminosity of light source. Firstly, after turning on the machine while the light luminosity still being unstable, scanning a document to get corresponding optoelectronic signals of pixels at different positions (step 20).

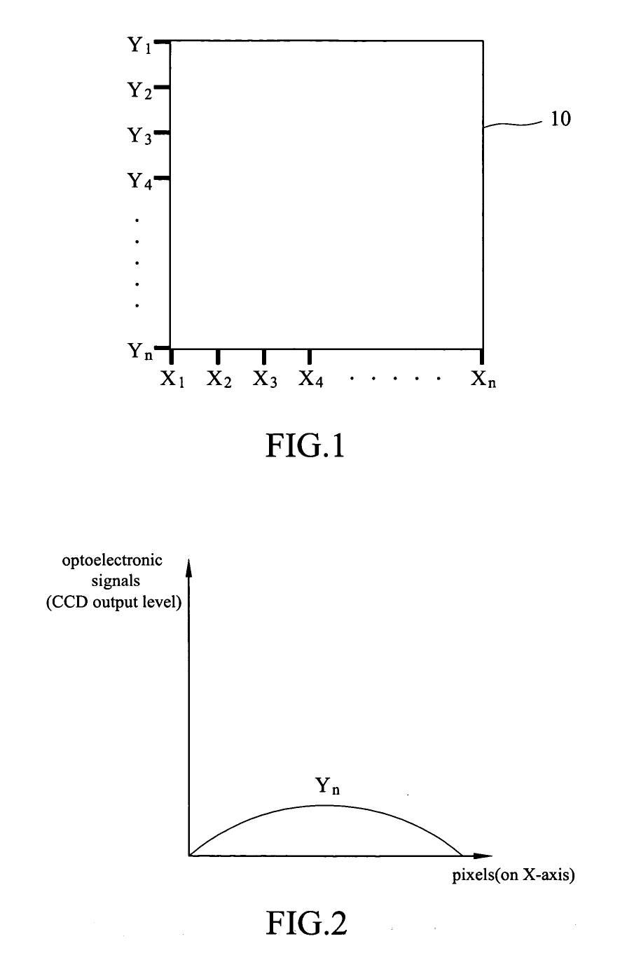

Further referring to FIG. 1, a flatbed window 10 applied to a scanner is defined with coordinates of X-axis(X1, X2, . . . , Xn) and Y-axis (Y1, Y2, . . . , Yn). After the scanner is started, an image sensor in the scanner gets, through scanning along X-axis at each positions of Y-axis, optoelectronic signals (CCD output) corresponding to the document pixels. When the optoelectronic module moves step by step along Y-axis, it gets the optoelectronic signals of full range of the flatbed window 10.

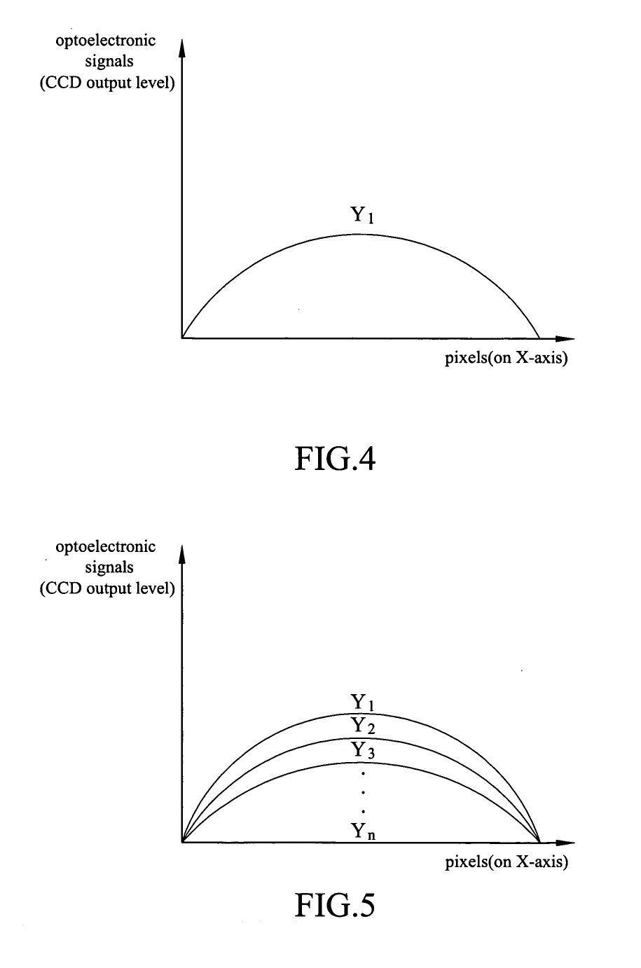

As shown in FIG. 4, at a position on Y-axis, the optoelectronic signals corresponding to document pixels on X-axis is a specific curve showing some inhomogeneity. Further, in FIG. 5, there are various curves of optoelectronic signals corresponding to different Y-axis positions.

Now, transferring the optoelectronic signals to a memory unit of the optoelectronic module for adjusting a shading table and parameters of an ASIC to compensate the brightness of each pixel, resemble a condition of stable luminosity, and generate an updated shading table (step 21).

The compensation is made by interpolation or multiplication. That is, multiplying each optoelectronic signal shown in FIG. 5 on a Y position with a suitable number to enlarge or reduce their amplitude and compensate the obtained brightness of pixels on the Y row. Different numbers are applied to different Y rows so as to update the shading table for resembling a condition of stable luminosity of the light source when the shading table is applied.

Finally, compensate the optoelectronic signals of each corresponding pixel according to the updated shading table, and obtain the scanned image data (step 22). The compensation solves the problem of luminosity changing and variation during starting of scanning so that an instant use of scanner is available. The method helps user starting instant-scan or previous-print after turning on the scanner or the multi-function printer so as to get instant response and convenience of operation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image signal modulation method applicable to an optical scanner composed of a light source, an image sensor and a memory unit to obtain compensated image when said light source is not stable during starting, and to perform instant-scan or previous-print, comprising steps of:
scanning a document to get corresponding optoelectronic signals of pixels at different positions;
transferring said optoelectronic signals to said memory unit for adjusting a shading table and parameters of an ASIC to compensate brightness of said pixels, and generate an updated shading table; and
compensating said optoelectronic signals of each corresponding pixel according to said updated shading table, and obtaining a scanned image data.

2. The image signal modulation method according to claim 1 wherein said step of scanning a document to get corresponding optoelectronic signals of pixels at different positions is performed by said image sensor.

3. The image signal modulation method according to claim 1 wherein said step of transferring said optoelectronic signals to said memory unit for adjusting a shading table and parameters of an ASIC to compensate brightness of said pixels, and generate an updated shading table is to transfer said optoelectronic signals to said memory unit and compensate brightness of said pixels through interpolation based on an original shading table.

4. The image signal modulation method according to claim 1 wherein said step of transferring said optoelectronic signals to said memory unit for adjusting a shading table and parameters of an ASIC to compensate brightness of said pixels, and generate an updated shading table is to transfer said optoelectronic signals to said memory unit and compensate brightness of said pixels through multiplication based on an original shading table.
